(19) United States
(12) Patent Application Publication
(10) Pub. No.: US 2021/0235727 A1
(43) Pub. Date: Aug. 5, 2021

(54) Barley Based Beverages

(71) Applicant: Carlsberg A/S, Copenhagen V (DK)

(72) Inventors: Morten Georg Jensen, Copenhagen V (DK); Birgitte Skadhauge, Copenhagen V (DK); Erik Lund, Copenhagen V (DK); Pia Vaag, Copenhagen V (DK); Zoran Gojkovic, Copenhagen V (DK)

(73) Assignee: Carlsberg A/S, Copenhagen V (DK)

(21) Appl. No.: 17/050,103

(22) PCT Filed: Apr. 25, 2019
(86) PCT No.: PCT/EP2019/060657

§ 371 Date: Oct. 23, 2020

(30) Foreign Application Priority Data
Apr. 25, 2018 (EP) 18169292.2
Sep. 10, 2018 (EP) 18193491.0

(51) Int. Cl. A23L 2/38; A23L 2/02; A23L 2/54

(52) U.S. Cl. CPC A23L 2/382; A23L 2/54; A23L 2/02

(57) ABSTRACT

The present invention relates to the field of beverages or beverage bases, in particular to the field of health beverages. The beverage or beverage base is produced by preparing an aqueous extract of unmalted cereal grains. Fermenting the aqueous extract by cold contact fermentation and/or with inactivated yeast to obtain a fermented aqueous extract. The aqueous extract or fermented aqueous extract is then mixed with a juice, to obtain an alcohol free or low alcohol beverage or beverage base with desirable ingredients.

### FIELD OF INVENTION

The present invention relates to the field of beverages, in particular to the field of health beverages. The beverages provided herein are cereal-based, and comprise fruit juice.

### BACKGROUND OF INVENTION

Barley has been consumed by mankind over several thousand years. It has been used to brew alcoholic beverages such as beer, and non-alcoholic beverages such as barley water or roasted barley tea. Barley water is nutritionally rich and is commonly believed to have many health benefits, such as promotion of weight loss, detoxification, soothing of urinary tract infections, and lowering of cholesterol levels. It is prepared by boiling barley, preferably pearled barley, and adding additional ingredients such as lemon, honey or additional flavours, and sieving the liquid. Barley water prepared in this manner has a short shelf life and should be used within a couple of days.

Roasted barley tea is a traditional Asian beverage prepared from roasted barley, subsequently boiled.

### SUMMARY OF INVENTION

The present invention provides beverages and beverage bases, which have an agreeable taste. The beverages and beverage basis are in general alcohol free or comprises only very low levels of alcohol and typically furthermore have low sugar content. The beverages contain desirable ingredients naturally present in cereal grains and are thus likely to have health benefits similar to traditional barley water. In addition, the beverages have good organoleptic properties, and e.g. comprise low levels of compounds detrimental to an agreeable taste. Furthermore, the beverages of the invention may be particularly stable and less likely to form undesired sediments during storage.

Thus, the invention provides methods of producing a beverage or a beverage base, comprising the steps of:
i) preparing an aqueous extract of unmalted cereal grains,
ii) fermenting the aqueous extract with yeast by cold contact fermentation or with inactivated yeast to obtain a fermented aqueous extract, and
iii) mixing said aqueous extract or fermented aqueous extract with a juice, thereby obtaining a beverage or a beverage base, wherein step iii) can be performed at any time during the method.

The invention also provides a beverage base prepared by the methods of the invention.

The invention further provides beverages comprising a beverage base prepared by the methods of the invention and one or more additional compounds and/or additional liquids.

### DESCRIPTION OF THE DRAWINGS

FIG. 1: Sedimentation of hull-less barley tea samples. S1: stabilised barley tea, to which juice concentrate was added and incubated for 24 hours before filtration. NS1: non-stabilised barley tea obtained by filtering the wort prior to addition of juice concentrate. Left panels: before centrifugation; right panels: after centrifugation.

FIG. 2: Flowchart of the production of a beverage or a beverage base. Cereal grains, water, CaCl₂) and selected enzymes are first added to a mash tun followed by mashing. This is followed by filtration by mash filer or a Lauter tun. The wort is then boiled in a wort kettle. After boiling wort in clarified in a Whirlpool. The wort is cooled and added washed yeast for about 24 hours at about 0° C. The yeast is then removed and the wort is mixed with PVPP and/or Silicagel. Juice can hereafter be added to the fermented aqueous extract before or after the filtration process, the order of the filtration depends on the desired haze formation in the final product. The resulting beverage or beverage base is then carbonated, bottled and pasteurized.

FIG. 3: Flavour profile of a fermented aqueous extract (#3). The fermented aqueous extract was prepared by using 100% hull-less barley variety, wherein the following enzymes were added: Glycoamylase (Attenuzyme® Core), beta-glucanase and xylanase (Ultraflo® Max), alpha-amylase (Termamyl®) and pullulanase (Ondea Pro®).

FIG. 4: Flavour profiles of beverages or beverage bases with A) Nordic berries-rosemary, B) Lime-elderflower, C) Lemon-Mint, or D) Apple-Green tea flavour.

### DETAILED DESCRIPTION OF THE INVENTION

### Definitions

The term “beverage base” as used herein refers to an aqueous composition, which is useful for preparing a beverage. In general, a beverage can be prepared from a beverage base by addition of one or more additional compounds and/or additional liquids. It is also possible that a beverage may be prepared by incubating a beverage base with plant material, thereby making an extraction of the plant material.

The term “barley” in reference to the process of making barley based beverages, means barley grains. In all other cases, unless otherwise specified, “barley” means the barley plant (Hordeum vulgare, L.), including any breeding line or cultivar or variety, whereas part of a barley plant may be any part of a barley plant, for example any tissue or cells.

The term “cereal” as used herein refers to any grass cultivated for the edible components of its grain (caryopsis), composed of the endosperm, germ, and bran. Non-limiting examples of useful cereal include barley, rye, sorghum, millet, wheat, rice, oat as well as pseudo-cereals such as quinona and amarent.

The term “grains” is defined to comprise the cereal caryopsis, also denoted internal seed, the lemma and palea. In most barley varieties, the lemma and palea adhere to the caryopsis and are a part of the kernel following threshing. However, naked barley varieties also occur; these are also termed hull-less barley. In these, the caryopsis is free of the lemma and palea and threshes out free as in wheat. The terms “kernel” and “grain” are used interchangeably herein.

The term “inactivated yeast” refers to a yeast which has been inactivated so as to substantially not perform proliferation and/or metabolism. The inactivated yeast may be inactivated alcohol-producing yeast and/or inactivated non-alcohol-producing yeast. The inactivated alcohol-producing yeast may be an alcohol-producing yeast that has been inactivated so as to substantially not produce an alcohol. The inactivated yeast may be dead yeast, i.e. yeast that has stopped its life activity. The dead yeast is obtained by, for example, subjecting living yeast to one or more treatments selected from the group consisting of heat treatment, acid treatment, freezing treatment, and drying treatment. The yeast may also be inactivated by artificial treatment (for example, one or more treatments selected from the group consisting of genetic engineering, chemical treatment, and light (for example, UV) treatment).

The term “juice” refers to a beverage made from the extraction or pressing out of the liquid naturally contained in fruits and vegetables; the term “juice” may also refer to a juice concentrate, obtained after removal of water from a juice.

The term “Mashing” as used herein refers to the incubation of milled cereal grains in water. Mashing is preferably performed at predetermined temperatures during predetermined time intervals. Mashing can occur in the presence of adjuncts, which is understood to comprise any carbohydrate source other than cereal grains, such as, but not limited to syrups, e.g. barley syrup or starch.

“Organoleptic properties” means properties of beverages as detected by the human olfactory and taste senses. These may be analyzed, for example, by a trained, specialized taste panel.

The term “plant material” refers to a plant or parts thereof. Said parts of a plant may for example be flowers, fruits, leaves, stems or roots.

The term “RTD” as used herein in relation to juice refers to “ready to drink”. Juice may be provided in the form of a concentrate, which must be diluted in order to arrive at a “ready to drink” juice. Typically, an RTD juice has a specific gravity in the range of 5 to 20° P, such as in the range of 5 to 15° P.

The term “sparging” as used herein refers to a process of extracting residual sugars and other compounds from spent grains after mashing with hot water. Sparging is typically conducted in a lauter tun, a mash filter, or another apparatus to allow separation of the extracted water from spent grains.

A “specialist beer taste panel” within the meaning of the present application is a panel of specialists extensively trained in tasting and describing beer flavors. Although a number of analytical tools exist for evaluating flavor components, the relative significance of flavor-active components are difficult to assess analytically. However, such complex properties can be evaluated by taste specialists. Their continuous training includes tasting and evaluation of standard beer samples.

The term “unmalted” as used herein in relation to cereal grains refers to a cereal grain, which has not germinated. Typically, visible sign of germination is the formation of a chit. Unmalted cereal grains do not comprise a visible chit.

The wort obtained after mashing is generally referred to as “first wort”, while the wort obtained after sparging is generally referred to as the “second wort”. If not specified, the term wort may be first wort, second wort, or a combination of both.

Method of Producing a Beverage or a Beverage Base

The present invention relates to a method of producing a beverage or a beverage base from unmalted cereal grains. The method may comprise the steps of:
i) preparing an aqueous extract of unmalted cereal grains, e.g. by any of the methods described herein below in the section “Preparing an aqueous extract”, wherein the cereal grains may be grains of any of the cereals described in the section “Cereal” herein below,
ii) fermenting the aqueous extract with yeast by cold contact fermentation or with inactivated yeast to obtain a fermented aqueous extract e.g. by any of the methods described herein below in the section “Fermentation”, and
iii) mixing said aqueous extract or fermented aqueous extract with a juice e.g. as described herein below in the section “Mixing with juice”, wherein the juice may be any of the juices described herein below in the section “Juice”,
thereby obtaining a beverage or a beverage base.

The steps of the method may be performed in the indicated order, however step iii) can be performed at any time during the method. Thus, said juice can be mixed with the aqueous extract or the fermented aqueous extract at any time during the method. In a preferred embodiment the steps are performed in the order: step i) followed by step ii) followed by step iii). In said embodiment, the juice is mixed with the fermented aqueous extract.

In some embodiments of the invention, the method comprising the steps indicated above results directly in the production of a beverage.

However, in some embodiments, the method comprising the steps indicated above results in the production of a beverage base, which may be further processed into a beverage. Thus, the method may comprise one or more additional steps of processing the beverage base into a beverage. Such step may for example be one or more of the following steps:
adding one or more additional compounds,
adding one or more additional liquids
incubating the aqueous extract, the fermented aqueous extract or the beverage base with a plant material
carbonating the beverage base, wherein said steps for example may be performed as described herein below in the section “Flavouring”.

In addition, to the steps indicated above, the method further comprises a step iv) of filtering the cereal-based beverage, which for example may be performed as described herein below in the section “Filtration”.

The present invention surprisingly discloses that particularly stable beverages can be produced by mixing the aqueous extract or the fermented aqueous extract with juice followed by filtering said mixture. Such beverages are less prone to formation of undesired sediments during storage.

Thus, in a preferred embodiment the step iv) of filtering is performed after steps i), ii) and iii).

The mixing may for example be performed as described herein below in the section “Mixing with juice”. In particular, the aqueous extract/fermented aqueous extract may be incubated with said juice for a predetermined time as described below prior to filtration.

The beverages or beverage bases of the present invention may in preferred embodiments be essentially natural beverage prepared using mainly or exclusively natural ingredients, such as cereal grains and pure fruit juice, as optionally natural flavouring. Thus, in some embodiments it may be preferred that no purified sugar or artificial sweetener is added to the beverage or beverage base.

### Cereal

The present invention relates to beverages prepared from cereal grains, as well as to methods of preparing such beverages.

The cereal grain may be the grain of any cereal, for example a cereal selected from the group consisting of barley, rice, sorghum, maize, millet, triticale, rye, oat and wheat. The cereal grain may also be grains of pseudo-cereals, such as quinoa and amaranth. Pseudo-cereals are plants, which comprises grains with high starch content.

The unmalted cereal grains to be used with the invention are typically dried cereal grains, e.g. they may have a water content of less than 15%.

Furthermore, the unmalted cereal grains to be used with the invention are typically milled or otherwise finely divided as described below in the section “Preparing an aqueous extract”.

In preferred embodiments of the invention the unmalted cereal grains are unmalted barley grains.

Said grains may be grains of any barley plant. However, in some embodiments, the barley plant may comprise one or more specific characteristics, for example, one or more of the characteristics as described herein below. Even though the various characteristics are discussed individually herein below, the barley plant of the invention may have a combination of these characteristics.

In one embodiment of the invention, the barley may be a hull-less barley variety (var.). It is also comprised within the invention that the barley is a barley var. with naturally thin husk, such as var. Admiral. For example, the husk may constitute less than 7% of the total weight of grain and husk.

In some embodiments it is preferred that some or even all of said barley is barley of a hull-less variety. Thus, at least 10% of the barley grains used may be hull-less barley, such as at least 20%, such as at least 30%, such as at least 40%, such as at least 50%, such as at least 60%, such as at least 70%, such as at least 80%, such as at least 90%, such as 100% of the barley grains used may be hull-less barley. It has been found that by using a barley variety with a thin husk or a hull-less barley variety, the beverages produced have reduced levels of off-flavour.

In some embodiments, in particular in embodiments, where the cereal grain is from a hulled cereal, e.g. from a hulled barley variety, the cereal grain may be pearled. Pearling involves mechanically removing the outer layer of cereal grains, e.g. removing the hull and the bran, and such methods are well known in art.

In another embodiment of the invention, the barley may be pearled barley. Thus wherein, at least 10% of the barley grains used may be pearled barley, such as at least 20%, such as at least 30%, such as at least 40%, such as at least 50%, such as at least 60%, such as at least 70%, such as at least 80%, such as at least 90%, such as 100% of the barley grains used may be pearled barley.

The barley plant may be a wild type barley plant. However, the barley plant may also carry one or more mutations. For example the barley may be a barley plant carrying one or more of the following mutations:
a mutation in the gene encoding LOX-1 causing a total loss of LOX-1 function
a mutation in the gene encoding LOX-2 causing a total loss of LOX-2 function
a mutation in the gene encoding MMT causing a total loss of MMT function.

Thus, the barley plant may be a barley plant having a low level of LOX activity. Such barley plants are known in the art, and include, for example, barley plants carrying a mutation in the gene encoding LOX-1. For example, the barley plant may be a barley plant carrying any of the mutations in the LOX-1 gene described in WO 02/053721, WO 2005/087934 and WO 2004/085652.

The barley plant may also be a barley plant carrying a mutation in the gene encoding lipoxygenase 1 (LOX-1) and/or in the gene encoding LOX-2. For example, the barley plant may be a barley plant carrying any of the mutations in the LOX-1 and LOX-2 genes described in WO 2010/075860.

The barley plant may also be a barley plant having a low level of MMT activity. Such barley plants are known in the art and include, for example, barley plants carrying a mutation in the gene encoding MMT. Specifically, the barley plant may be a barley plant carrying any of the mutations in the MMT gene described in WO 2010/063288. The barley plant may also be any of the barley plants described in WO 2011/150933.

### Preparing an Aqueous Extract

The methods of the invention typically comprise a step of preparing an aqueous extract of unmalted cereal grains. Typically, said aqueous extract is prepared by incubating said unmalted cereal grains in an aqueous solution, such as water. Before incubation in water, said unmalted cereal grains are preferably milled or otherwise finely divided. Milling may be performed using any conventional mill for milling cereal grains known in the art. Thus, the aqueous extract may be made from flour of cereal grains.

The aqueous extract may in particular be prepared by mashing the unmalted cereal grains, e.g. the milled or finely divided cereal grains. Mashing is a process well-known in beer production and it involves incubating the cereal grains in an aqueous solution at predetermined temperatures predetermined time intervals. In conventional beer production, milled malt is mashed, however similar procedures may be applied for mashing of unmalted cereals.

The aqueous solution may be any aqueous solution, but it typically consists of water, such as tap water to which one or more additional agents may be added herein also referred to as “additional mashing agents”. The additional mashing agents may be present in the mashing solution from the onset or they may be added during the process of preparing an aqueous extract.

Said additional mashing agents may also be adjuncts, for example syrups or sugars. Adjuncts such as sugars or syrups may be added to the mashing solution at any time in the process; however, such adjuncts may also be added to the aqueous extract or later during the process for preparing a beverage as described below. In general, the adjuncts are added in smaller quantities than the unmalted cereal grains. Thus, at least 50%, preferably at least 70%, for example at least 90% of the carbohydrates of the aqueous extract are derived from the unmalted cereal grains, whereas adjuncts preferably only accounts for a minor part of the carbohydrates.

The additional malting agents may also be salts, pH regulating agents and/or exogenous enzymes. For example, salts and/or pH regulating agents may be added in order to allow or optimise activity of one or more exogenous enzymes.

Said additional mashing agents, preferably of food grade quality, may also be a salt, for example CaCl₂), in the range of 0.25 to 0.75 g CaCl₂) per kg cereal grains (dry weight).

Said additional mashing agents may also be a pH regulating agent, such as an acid, preferably a food grade acid, for example H₃PO₄.
Mashing may be performed at any useful temperature. Said temperature may also be referred to as “mashing temperature” herein. Said mashing temperatures may for example be conventional temperatures used for conventional mashing.

The mashing temperature is in general either kept constant (isothermal mashing), or gradually increased, for example increased in a sequential manner. In either case, soluble substances in the unmalted cereal grains are liberated into the aqueous solution thereby forming an aqueous extract.

The mashing temperature(s) are typically temperature(s) in the range of 30 to 90° C., such as in the range of 40 to 85° C., for example in the range of 50 to 85° C. The mashing temperatures may be chosen according to the cereal type used. Accordingly, in embodiments of the invention, wherein the cereal grains are barley with low levels of or absent lipoxygenase (LOX) activity and/or methyl methionine transferase (MMT) activity (see details herein below in the section “Cereal”), the mashing temperature may be lower, for example in the range of 35 to 69° C.

The methods of the invention frequently comprises mashing in the presence of one or more exogenous enzymes, e.g. any of the enzymes described herein below in the section “Exogenous enzymes”. In such embodiments, mashing may be done at one or more predetermined temperatures selected in order to ensure activity of said one or more exogenous enzymes.

In some embodiment steps i) comprises or consists of mashing milled cereal grains in an aqueous solution at one or more predetermined temperatures in the range of 60 to 80° C. The time for mashing may be selected in order to allow sufficient extraction of carbohydrates (e.g. starch and sugars) from the milled cereal grains. As explained above, in some embodiments even lower temperatures may be used, e.g. temperatures in the range of 60 to 70° C.

Incubation in the aqueous solution may be performed for any suitable amount of time. The time for incubation in the aqueous solution may, e.g., be for in the range of 60 to 300 min, such as in the range of 60 to 240 min, for example in the range of 90 to 300 min. such as in the range of 90 to 240 min, for example in the range of 90 to 270 min. In another embodiment the mashing of milled cereal grains in an aqueous solution may be performed for in the range of 2 to 5 h. For example said time for incubation in the mashing solution may be any time used in conventional mashing.

One non-limiting example of a suitable mashing comprises or consists of the following steps:
a) Incubation of milled cereal grains in an aqueous solution at a first temperature between 60 and 68° C., such as in the range of 60 to 66° C., preferably 64° C., for a first duration of in the range of 60 to 90 minutes, preferably 75 minutes;
b) Incubation at a second temperature between 66 and 74° C., such as in the range of 70 to 73° C., preferably 72° C., for a second duration of in the range of 10 to 90 minutes, preferably 60 minutes;
c) Incubation at a third temperature between 72 and 80° C., such as in the range of 75 to 78° C., preferably 76° C., for a third duration of 10 to 60 minutes, preferably 25 minutes.

Other non-limiting examples of useful methods for mashing can be found in the literature of brewing, e.g. in Briggs et al. (supra) and Hough et al. (supra).

After incubation in the mashing solution, the aqueous extract may typically be separated, e.g. through filtration into the aqueous extract and residual non-dissolved solid particles, the latter also denoted “spent grain”. Filtering may for example be performed in a lauter tun. Alternatively, the filtering may be filtering through a mash filter.

Additional liquid, such as water may be added to the spent grains during a process also denoted sparging. After sparging and filtration, a secondary aqueous extract may be obtained. Further extracts may be prepared by repeating the procedure.

Thus, the aqueous extract may be the aqueous extract obtained after mashing, secondary or further aqueous extracts or a combination thereof.
The methods may further comprise a step of boiling said aqueous extract. The boiling may be performed in the presence of one or more additional compounds, such as salts or pH regulating agents. Said salt may for example be CaSO₄. Said pH regulating agents may be for example be an acid, such as H₃PO₄. The boiling may also be performed in the presence of one or more plant materials. Said plant materials may be added to flavour the beverage or beverage base, and the flavours of said plant material may be extracted during the boiling.
The boiling may be done for any suitable amount of time, e.g. in accordance with conventional methods for wort boiling. For example the aqueous extract may be boiled for in the range of 10 min to 2 h, such as in the range of 30 to 60 min.

### Exogenous Enzymes

The methods of the invention may comprise incubating unmalted cereal grains in an aqueous solution in the presence of one or more exogenous enzymes. In particular, the methods may comprise mashing unmalted cereal grains in the presence of one or more exogenous enzymes. Said exogenous enzymes may for example be one or more selected from the group consisting of a cellulase, a protease, a pullulanase, a xylanase, and an amylase.

Thus, the methods of the invention may comprise mashing in the presence of a cellulase. Said cellulase may for example be a beta-glucanase, such as an endo-(1,3;1,4)-β-glucanase or an endo-1,4-β-glucanase.

The methods may also comprise mashing in the presence of an exogenous xylanase, such as an endo- or exo-1,4-xylanase, an arabinofuranosidase or a ferulic acid esterase.

Said beta-glucanase and said xylanase may be provided as an enzyme mixture. Such mixtures are commercially available, e.g. as the Ultraflo® Max series from Novozymes or the Laminex® series from Dupont.

The methods of the invention may also comprise mashing in the presence of one or more starch degrading enzymes (e.g. amylases), e.g. in the presence of an amylase selected from the group consisting of beta-amylase, alpha-amylase and glucoamylase, for example in the presence of exogenous glucoamylase and/or alpha-amylase. Glucoamylase is also known as amyloglucosidase. Glucoamylase is commercially available, e.g. as the Attenuzyme® series from Novozymes or Diazyme® from Dupont. Alpha-amylas is commercially available, e.g. as Termamyl® from Novozymes or Amylex® from Dupont.

The methods may also comprise mashing in the presence of an exogenous pullulanase or a limit dextrinase.

In one embodiment mashing may be performed in the presence of exogenous glucoamylase, xylanase, beta-glucanase and alpha-amylase, wherein said exogenous enzymes may be the only exogenous enzymes added during mashing. This may in particular be the case in embodiments, wherein filtration is performed by Lautertun.

In one embodiment no exogenous protease is added during mashing. Addition of protease may be less preferable, because proteases may affect enzyme activity. In one embodiment no exogenous lipase is added during mashing.

Aforementioned exogenous enzymes are commercially available from e.g. DSM, Dupont or Novozymes. It is also comprised within the invention to use a commercial mixture of enzymes for brewing, such as Ondea Pro® (Novozymes).

In one embodiment mashing may be performed in the presence of an enzyme mix comprising alpha-amylase, pullulanase, protease, beta-glucanase, lipase and xylanase, e.g. Ondea Pro® (Novozymes) and a glucoamylase. This may in particular be the case in embodiments, wherein filtration is performed by mash filter filtration.

### Aqueous Extract and Fermented Aqueous Extract

The aqueous extract and the fermented aqueous extract prepared according to the methods of the invention may have several advantageous characteristics for example one or more of the characteristics described in this section.

The gravity of the aqueous extract is preferably at least 8° Plato, preferably at least 10° Plato. In a preferred embodiment the gravity of the aqueous extract obtained in step i) of the methods of the invention is between 10 and 20° Plato, such as in the range of 12 to 16° Plato. The gravity of the aqueous extract is mainly dependent on the sugar level and the “°Plato” as used herein is determined according to conventional methods in the art of beer brewing. In order to obtain a desirable gravity, the mashing conditions may be adjusted. If the gravity is too low, for example the mashing time may be extended and/or additional exogenous enzyme may be used. If the gravity is too high, the aqueous extract may for example be diluted by addition of water.

The aqueous extract may comprise a high level of glucose, for example at least 3 g/100 ml, preferably at least 4 g/100 ml, such as in the range of 4 to 10 g/100 ml, for example in the range of 4 to 8 g/100 ml. Thus, the aqueous extract obtained in step i) may comprise at least 4 g glucose per 100 ml.

The methods of the invention in general comprise a step of fermenting the aqueous extract. After fermentation, the gravity of the fermented aqueous extract may be adjusted, typically by dilution with water. The gravity of the diluted fermented aqueous extract may for example be between 1 and 5° Plato, such as between 2 and 4° Plato, such as in the range of 3.0 to 3.75° Plato. The diluted fermented aqueous extract may be mixed with juice in order to prepare the beverage.

### Fermentation

The methods of the invention comprise a step of fermenting the aqueous extract by cold contact fermentation and/or with inactivated yeast. One advantage of fermentation by cold contact or with inactivated yeast is that essentially no ethanol is produced during fermentation. Thus, it is preferred that the fermentation is performed in a manner so that the fermented aqueous extract comprises at the most 1% ethanol, preferably at the most 0.5% ethanol, even more preferably at the most 0.2% ethanol, such as at the most 0.05% ethanol. In preferred embodiments the fermented aqueous extract is essentially free of ethanol (i.e. the level of ethanol is below detection using standard measuring techniques). While essentially no ethanol is produced other advantages of fermentation is still obtained, such as reduction of the level of aldehydes and reduction in compounds resulting in reduced organoleptic properties of the beverage.

Said fermentation is generally performed by contacting the aqueous extract with yeast, such as a yeast selected from the group consisting of S. pastorianus, S. cerevisiae and S. brettanomyces. Thus, said yeast may be any yeast conventionally used in beer brewing.

Methods for cold contact fermentation are known in the art and have been described e.g., in U.S. Pat. Nos. 6,689,401 and 5,346,706.

However, the methods of the invention preferably employ a cold contact fermentation performed at very low temperature. In particular, it may be important that the aqueous extract is cooled to said low temperature before contacting the aqueous extract with said yeast.

In some embodiments the cold contact fermentation is performed at a temperature below 4° C., such as below 3° C., such as below 2° C., such as below 1° C., such as below 0.5° C., such as below 0.4° C., such as below 0.3° C., such as at approx. 0.2° C. In one embodiment the cold contact fermentation is performed at a temperature in the range of 0 to 4° C., even more preferably in the range of 0 to 1° C., yet more preferably in the range of −0.5 to 0.2° C. More preferably, the cold contact fermentation is performed at 0° C.

The cold contact fermentation may be performed for any desirable time, for example for a duration of 12 to 60 hours, such as for at least 16 h, for example for at least 20 h, such as for in the range of 20 to 60 h, for example for in the range of 20 to 50 h. In a preferred embodiment the cold contact fermentation is performed for in the range of 10 to 30 h, such as in the range of 10 to 24 h. It is preferred that above-mentioned temperature is maintained throughout the cold contact fermentation.

The fermentation may also be performed using inactivated yeast, which produces little or no ethanol during fermentation as described above. Said inactivated yeast may be yeast carrying one or more mutations resulting in reduced ability to produce ethanol. Said inactivated yeast may also be inactivated by heat treatment, e.g. by inactivation at a temperature of 40° C. or more, such as 50° C. or more, for example 60° C. or more. In particular, the yeast may be inactivated as described in US patent application US2015030749.

Mixing with Juice

The method of the invention comprises a step of mixing the aqueous extract or the fermented aqueous extract with juice. In preferred embodiments of the invention the juice is mixed with the fermented aqueous extract.

Said juice may be in the form of a juice concentrate or it may be a RTD juice. If the juice is in the form of a concentrate additional water may also be added to the aqueous extract of the fermented aqueous extract.

The ratio of aqueous extract or fermented aqueous extract to juice may be selected according to the desired taste of the beverage, but may for example be between 1:1 and 100:1, such as in the range of 2:1 and 50:1, for example in the range of 3:1 to 20:1, such as in the range of 4:1 to 10:1. Aforementioned ratios are provided as the ratio between (fermented) aqueous extract and RTD juice. In embodiments where a juice concentrate is employed, the concentrate corresponding to aforementioned levels of RTD juice should be employed, and optionally water may be added.

Thus, step iii) of the methods of mixing (fermented) aqueous extract with juice may be performed with 1 to 50% of juice, such as 2 to 40% of juice, such as 3 to 30% of juice, such as 4 to 20% of juice, such as 5 to 15% juice. Aforementioned % are provided in respect of RTD juice. If juice concentrate is used concentrate corresponding to aforementioned levels of RTD juice should be employed.
In some embodiments the methods comprise a step of filtration, which for example may be performed as described herein below in the section “Filtration”. In particular, said step of filtration may be performed after mixing the (fermented) aqueous extract with juice. The methods of the invention may also comprise a step of incubating said aqueous extract/fermented aqueous extract with said juice prior to said filtration. Thus, the aqueous extract or the fermented aqueous extract may be incubated with juice for a duration of 10 to 48 hours, preferably for at least 20 hours, such as for in the range of 20 to 48 h, for example for in the range of 20 to 30 h prior to filtration. Interestingly, the present invention demonstrates that beverages may be significantly stabilised by mixing the (fermented) aqueous extract with juice, incubating the mixture and subsequent filtration.

### Juice

The juice to be used with the present invention may be any juice. In particular, the juice is a pure fruit juice. As described above the juice may for example be provided in the form of a concentrate or as RTD juice.

The juice may be the juice of any fruit, such as berries, orange, apple, banana, lemon, lime, passion fruit, mango, pineapple, pears, kumquats, pomelo, pomegranate, rhubarb and/or grape. Non-limiting examples of useful juice includes apple juice and orange juice, preferably apple juice. The juice may be the juice of any vegetable, such as carrot juice.

In some embodiments it may be preferred that the juice is free of solid particles, e.g. that the juice is a fruit juice essentially clear of solid materials, such as pulp.

The gravity of the juice may for example be between 5 and 15° Plato, such as in the range of 8 to 12° Plato. Another measure for sugar content of a beverage is the BRIX value. RTD juice to be used with the present invention typically has an RTD in the range of 60 to 80, such as in the range of 65 to 71.

### Filtration

The methods of the invention may comprise a step of filtration, which preferably may be performed after mixing the (fermented) aqueous extract with juice. However, it is also comprised within the invention that the filtration is performed prior to addition of juice, e.g. after cold contact fermentation.

The filtration may be performed according to any conventional method employed to filter beverages. In one embodiment, the stabilization prior to filtration is performed by adding one or more absorbent particles to the mixture of (fermented) aqueous extract with juice and juice, followed by filtering the mixture through a filter. Useful absorbent particles are well known in the art and may for example be selected from the group consisting of polyvinylpolypyrrolidone and silica gels.

The filtration may be done through any useful filter, for example through cellulose filter plates, by kieselguhr filtration or by membrane filtration (cross flow).

### Beverage

The present invention also relates to beverages and beverage bases prepared by the methods described herein. The beverages prepared by the methods of the invention typically comprise a fermented aqueous extract of an unmalted cereal and juice. In addition, the beverage may comprise one or more additional compounds and/or additional liquids for example as described herein below in the section “Additional compounds and additional liquids”. The beverage may also be flavoured as described herein below in the section “Flavouring”. Even though a major part of the beverages/beverage bases is a fermented aqueous extract of a cereal, the beverages in general do not have a beer-like flavour. Furthermore, the beverages in general also do not comprise ethanol or comprise at the most 5% ethanol, preferably at the most 0.2% ethanol, such as at the most 0.05% ethanol.

The gravity of the beverage or the beverage base is typically between 1 and 12° Plato, such as between 1 and 10° Plato, such as between 2 and 9° Plato, such as between 3 and 8° Plato, such as between 5 and 8° Plato, such as between 4 and 7° Plato, such as between 6 and 8° Plato, such as between 5 and 6° Plato.

Thus, it may be preferred that the beverage or the beverage base comprises at the most 5% sugars (wlw). It may be preferred that no purified sugar is added to the beverages so that all sugar in the beverages derive from the aqueous extract of unmalted cereals and from fruit juice.

In some embodiments it may be preferred that the beverage or the beverage base does not comprise too much solid materials. Thus, preferably, the beverage or the beverage base comprises at the most 5 g of solid materials.
It is preferred that the beverages have good organoleptic properties. One challenge in preparing cereal based beverages is a grainy taste, which is often found non-agreeable. In particular, non-alcoholic beverages prepared from unmalted cereals, e.g. unmalted barley often have a grainy taste. Thus, in one embodiment the resulting beverages have essentially no grainy taste. For example said beverages may have a score for grainy taste of less than 0.3 when determined by a trained beer taste panel on a scale from 0 to 5, where 0 is not detectable and 5 is very strong.

### Additional Compounds and Additional Liquids

The beverages of the invention may comprise one or more additional compound(s) and/or additional liquids. The additional compound may for example be a flavoring compound, a preservative or a functional ingredient. The additional compound may also be a color, a sweetener, a pH regulating agent or a salt. The sweetener may for example be an artificial sweetener, a low calorie sweetener or sugar. In some embodiments it may however be preferred that the beverages do not comprise sweetener. The pH regulating agent may for example be a buffer or an acid, such as lactic acid or citric acid.

Functional ingredients may be any ingredient added to obtain a given function. Preferably a functional ingredient renders the beverage healthier. Non-limiting examples of functional ingredients includes soluble fibres, proteins, added vitamins or minerals.

The preservative may be any food grade preservative, for example it may be benzoic acid, sorbic acid, sorbates (e.g. potassium sorbate), sulphites and/or salts thereof.

The additional compound may also be a flavoring compound as described below in the section flavoring.

At least one additional compound may also be a stabilizer.

The additional liquid may be water. The additional liquid may also be another beverage, for example a syrup, a carbonated soft drink or a beer.

### Flavouring

The methods of the invention may also comprise flavouring the beverage or the beverage base. The flavouring may be performed at any time during the methods of preparing the beverage (base). Thus, the method may further comprise one or more of the following steps:
adding one or more additional compounds, e.g. any of the flavouring compounds or flavouring mixtures described in this section
incubating the aqueous extract, the fermented aqueous extract or the beverage base with a plant material
carbonating the cereal-based beverage base.

The flavouring compound to be used with the present invention may be any useful flavour compound. The flavouring compound or mixture may for example be selected from the group consisting of aromas, plant extracts, plant concentrates, plant parts and herbal infusions or aroma oils.

Thus, the flavouring compound may for example be an aroma. Aromas are typically organic compounds, for example they may be plant secondary metabolites. The aroma may be any aroma, for example a fruit aroma or vanilla aroma.

The plant extract may for example be a herbal extract. Non-limiting examples of herbal extracts includes an extract of green tea, black tea, rooibos, mint (e.g. peppermint) or hops. The plant extract may also be a flower extract. Non limiting examples of flower extracts include hibiscus, chamomile, elderflower, lavender or linden flower.

The plant extract may also be a fruit extract. Plant material may for example be dried or fresh herbs, such as hops pellets, dried of fresh flowers or fruits.

The flavouring compound may for example be a botanical flavouring compound such as cinnamon.

The plant concentrate may be a fruit concentrate, for example a fruit juice, which has been concentrated by removal of water.

Non-limiting examples of fruits useful for fruit aroma, aroma oils, fruit extract or fruit concentrates include berries, orange, apple, banana, lemon, lime, passion fruit, mango, pineapple, pears, kumquats, pomelo, pomegranate, carrot, rhubarb or grape.

It is comprised within the invention that the beverages may comprise more than one flavouring compound or mixture.

The flavouring compound may also be quinine, for example in embodiments where the beverage is a tonic like beverage.

The beverages may also comprise CO₂. In particular, CO₂ may be added to obtain a carbonated beverage.

In one preferred embodiment it is preferred that the beverages comprise no added preservatives. In one preferred embodiment it is preferred that the beverages comprise no added sweetener, e.g. no added sugar. In one preferred embodiment it is preferred that the beverages comprise no added pH regulator, e.g. no added buffer. It is understood that whereas the beverages may naturally contain any of aforementioned compounds, in some embodiments it is preferred that no compound is specifically added with the aim to function as preservative, sweetener and/or pH regulator.

### Items

The invention may further be defined by one or more of the following items:
1. A method of producing a beverage or a beverage base, comprising the steps of:
   i) preparing an aqueous extract of unmalted cereal grains,
   ii) fermenting the aqueous extract with yeast by cold contact fermentation or with inactivated yeast to obtain a fermented aqueous extract, and
   iii) mixing said aqueous extract or fermented aqueous extract with a juice, thereby obtaining a beverage or a beverage base,
   wherein step iii) can be performed at any time during the method.
2. The method item 1, wherein the cereal is selected from the group consisting of barley, rye, sorghum, millet, wheat, oat and rice.
3. The method of any one of the preceding items, wherein the cereal is barley.
4. The method of any one of the preceding items, wherein step i) comprises mashing milled cereal grains in an aqueous solution in the presence of one or more exogenous enzymes selected from the group consisting of a cellulase, a protease, a pullulanase, a xylanase, and an amylase.
5. The method of item 4, wherein the cellulase is a beta-glucanase.
6. The method according to any one of items 4 to 5, wherein the step i) comprises mashing milled cereal grains in an aqueous solution in the presence of one or more exogenous amylases selected from the group consisting of glucoamylase and alpha-amylase.
7. The method according to any one of the preceding items, wherein the step i) comprises mashing milled cereal grains in an aqueous solution in the presence exogenous glucoamylase, xylanase, beta-glucanase and alpha-amylase.
8. The method according to any one of items 1 to 6, wherein the step i) comprises mashing milled cereal grains in an aqueous solution in the presence exogenous glucoamylase, alpha-amylase, pullulanase, protease, beta-glucanase, lipase and xylanase.
9. The method of any one of the preceding items, wherein the steps are performed in the following order: step i) followed by step ii) followed by step iii).
10. The method of any one of the preceding items, wherein the method further comprises a step iv) of filtering the cereal-based beverage.
11. The method according to item 8, wherein said step iv) of filtering comprises adding one or more absorbent solid particles to the mixture of aqueous extract or fermented aqueous extract and juice, and filtering the mixture through a filter.
12. The method according to item 9, wherein the absorbent particles are one or more selected from the group consisting of polyvinylpolypyrrolidone and a silica gel.
13. The method of item 5, wherein the step iv) is performed after steps i), ii) and iii).
14. The method according to any one of the preceding items, wherein the method further comprises one or more of the following steps:
   adding one or more additional compounds
   incubating the aqueous extract, the fermented aqueous extract or the beverage base with a plant material
   carbonating the beverage base.
15. The method according to any one of items 3 to 12, wherein at least 10% of the barley is a hull-less barley, such as at least 20%, such as at least 30%, such as at least 40%, such as at least 50%, such as at least 60%, such as at least 70%, such as at least 80%, such as at least 90%, such as 100% of the barley is a hull-less barley.
16. The method according to any one of items 3 to 12, wherein at least 10% of the barley is pearled barley, such as at least 20%, such as at least 30%, such as at least 40%, such as at least 50%, such as at least 60%, such as at least 70%, such as at least 80%, such as at least 90%, such as 100% of the barley is pearled barley.
17. The method according to any one of items 3 to 13, wherein at least some of the barley is a barley plant carrying one or more of the following mutations:
   a mutation in the gene encoding LOX-1 causing a total loss of LOX-1 function
   a mutation in the gene encoding LOX-2 causing a total loss of LOX-2 function
   a mutation in the gene encoding MMT causing a total loss of MMT function.
18. The method of any one of the preceding items, wherein the aqueous extract or fermented aqueous extract is incubated with juice for a duration of 10 to 48 hours, preferably for at least 20 hours, such as for in the range of 20 to 48 h, for example for in the range of 20 to 30 h prior to step iv).
19. The method according to any one of the preceding items, wherein step i) comprises or consists of mashing milled cereal grains in an aqueous solution at a temperature in the range of 60 to 80° C.
20. The method according to any one of the preceding items, wherein step i) comprises or consists of mashing milled cereal grains in an aqueous solution for in the range of 2 to 5 h.
21. The method of any one of the preceding items, wherein the aqueous extract is prepared in the presence of CaCl₂).
22. The method of any one of the preceding items, wherein the gravity of the aqueous extract obtained in step i) is between 10 and 20° Plato, such as in the range of 12 to 16° Plato.
23. The method according to any one of the preceding items, wherein the aqueous extract obtained in step i) comprises at least 4 g glucose per 100 ml.
24. The method of any one of the preceding items, wherein the method further comprises a step of boiling the aqueous extract.
25. The method of item 22, wherein boiling is performed in the presence of H₃PO₄ and/or CaSO₄.
26. The method of any one of the preceding items, wherein cold contact fermentation is performed at a temperature below 4° C., such as below 3° C., such as below 2° C., such as below 1° C., such as below 0.5° C., such as below 0.4° C., such as below 0.3° C., such as 0.2° C.
27. The method according to any one of the preceding items, wherein cold contact fermentation is performed at a temperature in the range of −0.5 to 0.2° C.
28. The method of any one of the preceding items, wherein cold contact fermentation is performed for a duration of 12 to 60 hours, such as for at least 16 h, for example for at least 20 h, such as for in the range of 20 to 60 h, for example for in the range of 20 to 50 h.
29. The method according to any one of the preceding items, wherein the cold contact fermentation is performed for in the range of 10 to 30 h.
30. The method of any one of the preceding items, further comprising diluting the fermented aqueous extract.
31. The method of item 26, wherein the gravity of the diluted fermented aqueous extract is between 1 and 5° Plato, such as between 2 and 4° Plato, such as in the range of 3.0 to 3.75° Plato.
32. The method of any one of the preceding items, wherein the juice is fruit juice, such as apple juice, orange juice, lemon juice, pomegranate juice, rhubarb juice, grape juice, preferably apple juice.
33. The method according to any one of the preceding items, wherein the juice is a fruit juice essentially clear of solid materials.
34. The method of any one of the preceding items, wherein the juice gravity is between 5 and 15° Plato, such as in the range of 8 to 12° Plato.
35. The method of any one of the preceding items, wherein the ratio of aqueous extract or fermented aqueous extract to juice is between 1:1 and 100:1, such as in the range of 2:1 and 50:1, for example in the range of 3:1 to 20:1, such as in the range of 4:1 to 10:1.
36. The method of any one of the preceding items, wherein the gravity of the beverage or the beverage base is between 1 and 12° Plato, such as between 1 and 10° Plato, such as between 2 and 9° Plato, such as between 3 and 8° Plato, such as between 5 and 8° Plato, such as between 4 and 7° Plato, such as between 6 and 8° Plato, such as between 5 and 6° Plato.
37. The method according to any one of the preceding items, wherein the beverage or the beverage base comprises at the most 5% sugars (wlw).
38. The method of any one of the preceding items, wherein step iii) is performed with 1 to 50% of juice, such as 2 to 40% of juice, such as 3 to 30% of juice, such as 4 to 20% of juice, such as 5 to 15% juice.
39. The method according to any one of the preceding items, wherein the beverage or the beverage base comprises at the most 5 g of solid materials.
40. The method according to any one of the preceding items, wherein no purified sugar or artificial sweetener is added to the beverage or beverage base.
41. A beverage comprising a beverage base prepared by the method according to any one of items 1 to 36 and one or more additional compounds and/or additional liquids.
42. The beverage according to item 37, wherein said additional compounds may be one or more selected from the group consisting of salts, pH regulating agents, flavouring compounds, preservatives, functional ingredients, stabilisers and CO₂.
43. A beverage or a beverage base obtainable by the method of any one of items 1 to 36.
44. The beverage according to any one of items 37 to 39, said beverage comprising 1 to 50% of juice, such as 2 to 40% of juice, such as 3 to 30% of juice, such as 4 to 20% of juice, such as 5 to 15% juice.
45. The beverage according to any one of items 37 to 40, wherein the beverage comprises at the most 5 g of solid materials.

### EXAMPLES

### Example 1

In the mash tune, 100% barley of a hull less variety was mixed in 64° C. water. The barley was milled according to standard EBC milling for beer brewing prior to addition to the mash tune.

### Ingredients

Details of all the ingredients added throughout the preparation of the beverage are described in the table 2 below:

TABLE 2

| INGREDIENTS | Trial 1 | |
|---|---|---|
| MASH VESSEL | | |
| Barley Hull Less | 100% | |
| Dilution | 4 | |
| CaCl₂ | 30 | g/hL CW |
| Pullulanase (Ondea Pro ®) | 2 | g/kg RM |
| Amyloglucosidase (AMG) | 3 | g/kg RM |
| WORT KETTLE | | |
| CaSO₄ | 18 | g/hL CW |
| H₃PO₄ | 40 | mL |

| | |
|---|---|
| ZnSO₄ | 0 |

In addition to pullulanase (Ondea Pro® enzyme, available from Novozymes, Denmark), amyloglucosidase (AMG, available from DSM) was added to improve the starch hydrolysis.

### Mashing Process Description

Mashing was performed in the mash vessel with the ingredients described in Table 2. The mashing regime is described in Table 3.

TABLE 3

| | | Temperature | Diff | |
|---|---|---|---|---|
| Time | Temperature | Gradient | Temperature | Duration |
| Minutes | ° C. | ° C./min | ° C. | minutes |
| Start | 60 | | | |
| 5 | 64 | Mashing | | 5 |
| 65/80 | 64 | Target | | 60/75 |
| | | temperature | | |
| 70/88 | 72 | 1 | 8 | 8 |
| 100/148 | 72 | Target | | 10/60 |
| | | temperature | | |
| 110/152 | 76 | 1 | 4 | 4 |
| 120/177 | 76 | Target | | 10/25 |
| | | temperature | | |

To allow a more efficient filtration (without clogging), the three target temperatures (64° C., 72° C. and 76° C.) were extended during mashing to ensure optimal starch hydrolysis.

Filtration Process with Mash Filter

During this process, mash is filtered through a mash filter. Once the first filtration is complete, the remaining grains may be sparged. The volume of water was determined as follows: 2.5×the quantity of raw material. The filtration was stopped (after the final compression) when the wort gravity in hop kettle was about 14° P.

### Wort Kettle and Whirlpool

The ingredients described in Table 2 were added and the wort was boiled in a wort kettle.

Table 4 describes the performance of the wort kettle and gives details of wort transfer:

TABLE 4

| | Units | Trial 2 |
|---|---|---|
| PARAMETERS WORT KETTLE | | |
| Weight wort kettle after boiling | Kg | 93.95 |
| Gravity after boiling | ° Plato | 14 |
| Time of boil | Min | 60 |
| Evaporation | % | 2.13 |
| PARAMETERS WHIRLPOOL | | |
| Duration | Min | 20 |
| Weight | Kg | 91.50 |
| PARAMETERS WORT TRANSFER | | |
| Duration | Min | 21 |
| Temperature | ° C. | 10 |
| Mean turbidity after whirlpool | EBC | 6 |
| PARAMETERS COLD WORT | | |
| Gravity cold wort | ° P | 13.71 |
| Yield wort (DM) | % | 73.5 |
| Yield wort (WM) | % | 63.7 |

TABLE 5
Process data of trial 1

| PARAMETERS | Units | Data |
|---|---|---|
| Raw mat. weight Wet. | Kg | 18.3 |
| Moisture | % | 13.30 |
| Raw mat. weight Dry | Kg | 15.9 |
| Total weight MT | Kg | 90.60 |
| Dilution MT | | 4 |
| Gravity 1° wort | ° PI | 15.71 |
| Weight 1° wort | Kg | 44.75 |
| %1° wort | % | 49 |
| Gravity end filtration | ° PI | 4.68 |
| Weight Wort K. end filtration | Kg | 96 |
| Gravity Wort K. end filtration | ° PI | 13.51 |
| Mash filter step duration | Min | 102 |
| Gravity Wort K. after boiling | ° PI | 14 |
| Weight after boiling | Kg | 93.95 |
| Remaining in WH | Kg | 1.05 |
| Wort weight | Kg | 92.9 |
| Gravity cold wort | ° PI | 13.71 |
| Filtration mean flow | kg/min | 0.94 |
| pH Wort K * | | 5.10 |
| Boiling time | Min | 60 |
| Yield MF | % DM | 74.8 |
| Yield MF | % WM | 64.8 |
| Extraction | % | 91.1 |

Analysis of the wort is detailed in the table below:

TABLE 6
wort analyses

| WORT ANALYSES | Units | Trial 1 |
|---|---|---|
| Fructose (W/V) | g/100 ml | 0.09 |
| Glucose (W/V) | g/100 ml | 4.89 |
| Sucrose (W/V) | g/100 ml | 0.22 |
| Maltose (W/V) | g/100 ml | 4.22 |
| Maltotriose (W/V) | g/100 ml | 0.43 |
| Total fermentable sugars | g/100 ml | 9.85 |
| Total reversed sugars (Fructose + | g/100 ml | 3.94 |
| glucose + sucrose.) | | |
| Total nitrogen | mg/100 ml | 78.4 |
| Colour | EBC | 2.2 |
| FAN | mg/l | 92.4 |
| Total sugars | g/100 ml | 14 |
| pH | | 5.07 |
| Soluble Beta Glucans | mg/l | 114 |
| Viscosity at 20° C. | c.p. | 1.85 |
| Extract of wort | ° plato | 13.65 |
| Total prot./WW | % | 0.32 |
| Limit gravity | ° plato | 1.54 |
| Limit attenuation | % | 88.72 |
| DMS | Ppb | 14 |
| Pr-DMS | Ppb | 0 |

### Cold Contact Fermentation

The wort was in contact with washed Brewer's yeast at 0.2° C. during 24 hours. Then, it was diluted to 3.75° Plato. Apple juice (10° Plato) (RTD) was added to the diluted wort and the resulting composition was mixed (80% of wort with 20% of juice). It stayed for 24 hours at 0.2° C. with PVPP and Silicagel. Final juice gravity was 5.05° Plato.

The resulting composition was filtered. For the final filtration, 7 g of PVPP and 7 g of Silicagel were added to 14 kg of wort (based on 80% of wort at 3.75° P and 20% of apple juice at 10° P). After 24 hours at 0.2° C., the product was filtered through a Kieselguhr filter.

The resulting beverage was carbonated, bottled and pasteurised (20 UP°).

### Example 2

The purpose of the experiment was to document barley tea (BT) base stability.

The Samples Compared were:

S1: hull-less barley tea prepared as described in Example 1, wherein preparation included stabilization steps, i.e. addition of juice (RTD) to wort fermented by cold contact fermentation and incubation for 24 h followed by standard filtration.

NS1: hull-less barley tea prepared essentially as described in Example 1 except that juice (RTD) was added after the final filtration of the wort, i.e. no stabilization step.

Samples were triplicates (S1, S2, S3 vs. NS1, NS2, NS3). The main parameters assessed were:
visual assessment of haze formation; and
sedimentation measured after centrifugation.

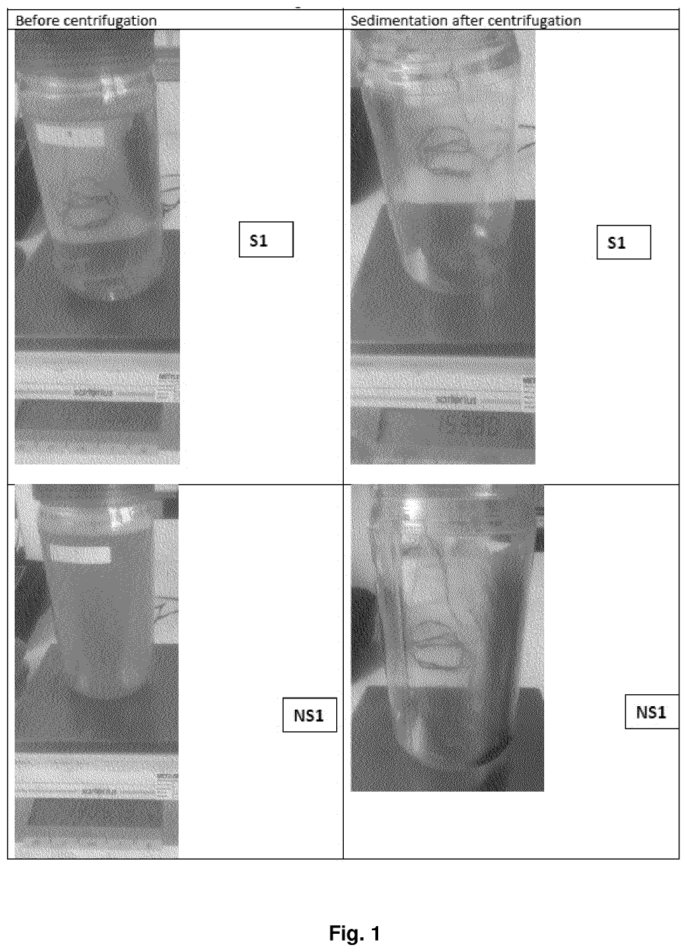

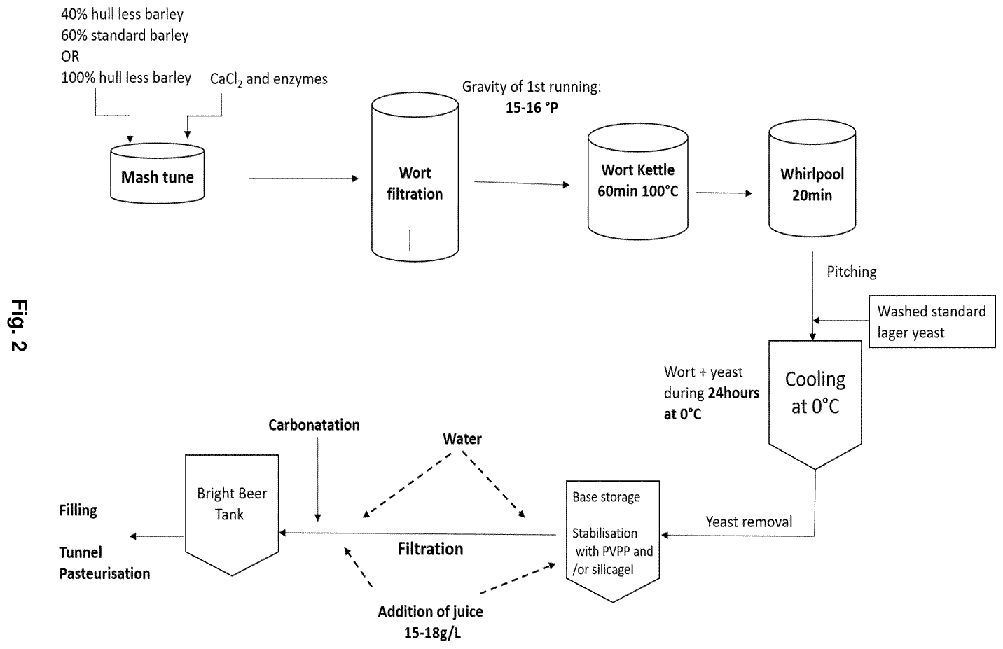

FIG. 1 shows samples sedimentation before and after centrifugation for representative samples S1 and NS1. Haze formation and sedimentation were higher in the non-stabilised samples than in the stabilised samples. Quantitative data for S1 and NS1 are shown in table 7:

TABLE 7
sediment after centrifugation for S1 + NS1

| | Weight of | Weight of | |
|---|---|---|---|
| | sediments for | sediments for | |
| | stabilised | non-stabilised | Δ - weight of |
| Sample | barley tea (g) | barley tea (g) | sediments (g) |
| 1 | 1.27 | 16.25 | |
| 2 | 1.52 | 15.96 | |
| 3 | 1.61 | 16.42 | |
| Mean (stdev) | 1.47 (0.17) | 16.21 (0.23) | −14.74 |

In conclusion, a strong haze formation in non-stabilized barley tea samples compared to stabilized barley tea samples was observed. The formed sedimentation was quantified by weight measurements of sediments after centrifugation. Higher amount of sedimentation was found in barley tea where juice concentrate was mixed after filtration compared to barley tea where mixing of barley wort with juice concentrate was done prior to filtration. Without being bound by theory, it is speculated that mixing juice concentrate and wort allows formation of polyphenol-protein complexes binding leading to strong sedimentation, and that addition of juice prior to filtering facilitates removal of sedimenting materials.

### Example 3

Two different beverage bases (herein denoted #22 and #27) were prepared essentially as described in Example 1 with the following changes.

### Barley

#22: 100% of a hull-less barley variety

#27: 40% of a hull-less barley variety and 60% conventional barley).

### Exogenous Enzymes Added During Mashing

#22: Pullulanase (Ondea Pro®, from Novozymes) and amyloglucosidase (AMG, from DSM)

#27: Glycoamylase (Attenuzyme® Core), beta-glucanase and xylanase (Ultraflo® Max) and alpha-amylase (Termamyl®)—all from Novozyme, Denmark.

Cold Contact Fermentation:

The wort was cooled to 0° C., and was contacted with washed yeast and incubated at 0° C. for 24 hours. Then, it was diluted 1:1 with water and filtered.

Apple juice was added to a final content in the beverage base of RTD apple juice of 7.5%.

The resulting beverage bases (#22 and #27) were tested as such or different flavours were added before testing.

Alcohol content of the beverages was determined by standard gas chromatography. The beverages based on beverage base #22 had an alcohol content of 0.032 to 0.040% ABV. The beverages based on beverage base #27 all had an alcohol content of 0.04% ABV. ABV is an abbreviation of “alcohol by volume”.

A taste testing was done by a trained beer taste panel and scores were given for a number of organoleptic properties on a scale from 0 (not detectable) to 5 (very strong). The overall taste profiles were similar, but it was notable that the beverages prepared from 100% hull-less barley (#22) has essentially no “grainy” flavour with scores of 0 in 3 of 4 tests and 0.25 in the last test. In contrast the beverages prepared from a mixture of conventional and hull-less barley all had detectable grainy flavour with scores in the range of 0.25 to 0.6 in 4 tests.

### Example 4

Four different fermented aqueous extracts (herein denoted #1, #2, #3 and #4) were prepared essentially as described in Example 1 with the following changes:

### Barley

#1: 100% of a hull-less barley variety

#2: 40% of a hull-less barley variety and 60% conventional barley

#3: 100% of a hull-less barley variety

#4: 40% of a hull-less barley variety and 60% conventional barley

### Exogenous Enzymes Added During Mashing

#1: Glucoamylase (Diazyme®), beta-glucanase and xylanase (Laminex®), alpha-amylase (Amylex®) and pullulanase (Ondea Pro®)

#2: Glucoamylase (Diazyme®), beta-glucanase and xylanase (Laminex®), and alpha-amylase (Amylex®)

#3: Glycoamylase (Attenuzyme® Core), beta-glucanase and xylanase (Ultraflo® Max), alpha-amylase (Termamyl®) and Pullulanase (Ondea Pro®)

#4: Glycoamylase (Attenuzyme® Core), beta-glucanase and xylanase (Ultraflo® Max) and alpha-amylase (Termamyl®)

FIG. 2 shows a flowchart of the brewing process for the fermented aqueous extracts #1, #2, #3 and #4, as well as the further steps of obtaining a final beverage or beverage base.

As seen from the flowchart, depending on the desired final product, the addition of juice can be performed before and/or after filtering of the fermented aqueous extract.

If juice is added before filtration of the fermented aqueous extract, a low amount of haze is produced, i.e. resulting in a clear final product. Opposite, if juice is added after the fermented aqueous extract is filtered, a haze formation will occur in the final product.

Characterisation of the fermented aqueous extract #3 is detailed in the table below:

TABLE 8

| | Fermented aqueous extract | Range |
|---|---|---|
| ° Plato | 7.0 | ±0.5 |
| Alcohol, % vol | 0.0 | +0.3 |
| PH | 4 | ±0.5 |
| Vicinal diketones (VDK), ppm | 0.1 | ±0.1 |
| Diacetyl, ppb | 50 | ±50 |
| Bitterness, BU | 0 | +10 |
| Perceived bitterness (EBUG) | 0 | +10 |
| SO2, ppm | 10 | ±5 |

A flavour profile of the fermented aqueous extract was analysed and the flavour intensities were rated according to:

0 to 5 with 0.5 points interval for the mandatory terms and 1 point interval for the additional terms

Intensity Rating Points of Reference:

0=absent
1=low
3=medium
5=high

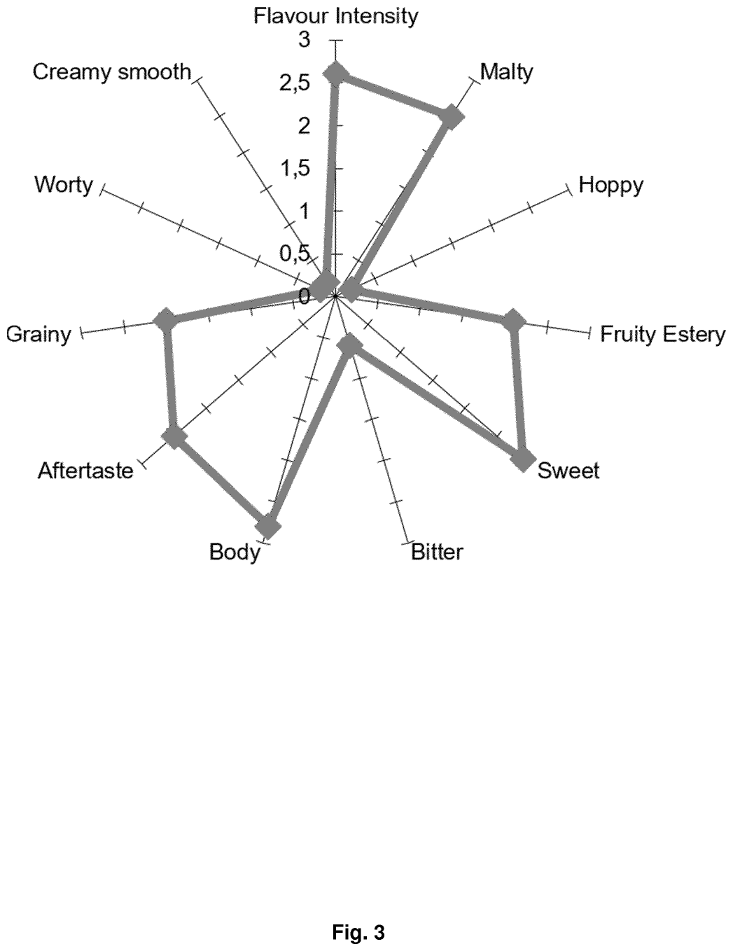

The flavour profile is detailed in the table below, as well as in FIG. 3.

TABLE 9

| | Variable | Intensity |
|---|---|---|
| Core Flavour | Flavour Intensity | 2.6 |
| Attributes | Malty | 2.5 |
| (Mandatory) | Hoppy | 0.2 |
| | Fruity Estery | 2.1 |
| | Sweet | 2.9 |
| | Bitter | 0.6 |
| | Body | 2.8 |
| | Aftertaste | 2.5 |
| Additional | Grainy | 2 |
| Attributes | Worty | 0.2 |
| | Creamy smooth | 0.2 |

To obtain different flavour profiles of the beverage or beverage base, different juice bases can be added to the fermented aqueous extract.

### Example 5

Four different beverages or beverage bases were produced by mixing the fermented aqueous extract, prepared according to example 4, with one of the following juice concentrates:
1500 g/hl Nordic berries-Rosemary
1700 g/hl Lime-Elderflower
1800 g/hl Lemon-Mint
1700 g/hl Apple-Green Tea

The juice base and the fermented aqueous extract were mixed after the fermented aqueous extract was filtered.

It must be noted that in this example the juice is added as a concentrate and not as RTD.

The final blending's were analysed and the target value ranges are shown in the table below:

TABLE 10

| | Nordic berries- | Lime- | Lemon- | Apple- |
|---|---|---|---|---|
| | Rosemary | Elderflower | Mint | Green Tea |
| ° Plato | 7.8* ± 0.2 | 8.0^{#} ± 0.2 | 8.0^{#} ± 0.2 | 7.8* ± 0.2 |
| Alcohol, % vol | 0-max 0.044 | 0-max 0.044 | 0-max 0.044 | 0-max 0.044 |
| PH | 4 ± 0.2 | 4 ± 0.2 | 4 ± 0.2 | 4 ± 0.2 |
| Vicinal diketones | 0.1 | 0.1 | 0.1 | 0.1 |
| (VDK), ppm | | | | |
| Diacetyl, ppb | 50 | 50 | 50 | 50 |
| Bitterness, BU | 0 (no | 0 (no | 0 (no | 0 (no |
| | hops) ± 2 | hops) ± 2 | hops) ± 2 | hops) ± 2 |
| Perceived Bitterness | 0 (no | 0 (no | 0 (no | 0 (no |
| (EBUG) | hops) ± 2 | hops) ± 2 | hops) ± 2 | hops) ± 2 |
| Fermentable sugars, g/l | 6 ± 0.3 | 6 ± 0.3 | 6 ± 0.3 | 6 ± 0.3 |
| Haze, EBC at 20° C. | max 7 | max 7 | max 7 | max 7 |
| CO2 g/l btls/cans | 5.4 ± 0.3 | 5.4 ± 0.3 | 5.4 ± 0.3 | 5.4 ± 0.3 |
| SO2, ppm | 10 ± 5 | 10 ± 5 | 10 ± 5 | 10 ± 5 |
| Total oxygen, ppb | 250 | 250 | 250 | 250 |

7° P is coming from the fermented aqueous extract (brew base) and *0.8° P or ^{#}1.0° P is coming from the juice.

Thus, all sugar in the beverages derive from the aqueous extract of unmalted cereals and from fruit juice. No purified sugar is added to the beverages.

A flavour profile of all four beverages or beverage bases were performed and shown in the table below.

As in example 4, the flavour intensities were rated by the following:

0 to 5 with 0.5 points interval for the mandatory terms and 1 point interval for the additional terms

Intensity Rating Points of Reference:

0=absent
1=low
3=medium
5=high

TABLE 11

| | | Nordic berries - | Lime - | Lemon- | Apple- |
|---|---|---|---|---|---|
| | | Rosemary, | Elderflower | Mint | Green tea |
| | Variable | (Intensity) | (Intensity) | (Intensity) | (Intensity) |
| Core | Flavour | 3.7 | 3.4 | 3.4 | 3.5 |
| Flavour | Intensity | | | | |
| Attributes | Malty | 1.4 | 1.5 | 1.6 | 1.4 |
| (Mandatory) | Hoppy | 0.0 | 0.1 | 0.1 | 0 |
| | Fruity/Estery | 3.6 | 3.4 | 3.2 | 3.4 |
| | Sweet | 3.0 | 2.8 | 3 | 2.8 |
| | Bitter | 0.7 | 0.6 | 0.5 | 0.6 |
| | Body | 3.1 | 3.1 | 3 | 3.1 |
| | Aftertaste | 3.3 | 3.1 | 3.2 | 3.3 |
| Additional | Grainy | 0.4 | 0.5 | 0.6 | 0.4 |
| Attributes | Worty | 0.4 | NA | NA | NA |
| | Sour | 1.1 | 1.3 | 0.9 | 1 |
| | Nordic berries | 2.5 | NA | NA | NA |
| | Rosemary | 0.8 | NA | NA | NA |
| | Sweet coating | 0.4 | NA | 0.3 | 0.5 |
| | mouthfeel | | | | |
| | Lime | NA | 2.4 | NA | NA |
| | Elderflower | NA | 1.8 | NA | NA |
| | Lemon | NA | NA | 2.4 | 0 |
| | Mint | NA | NA | 2 | NA |
| | Caramel | NA | NA | 0.3 | NA |
| | Astringency | NA | NA | 0.3 | 0.4 |
| | Green tea | NA | NA | NA | 2 |
| | Apple | NA | NA | NA | 2.1 |

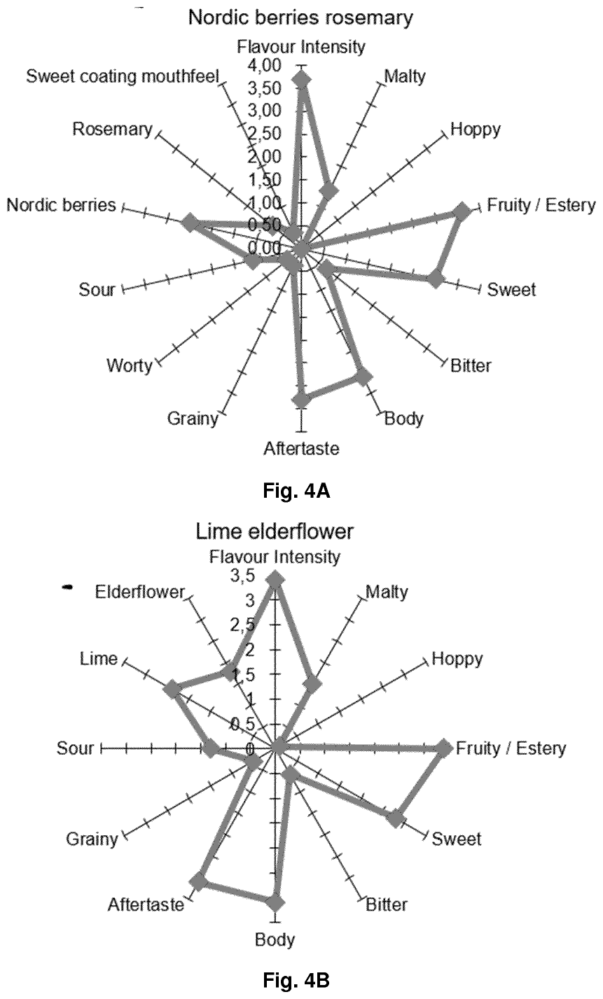

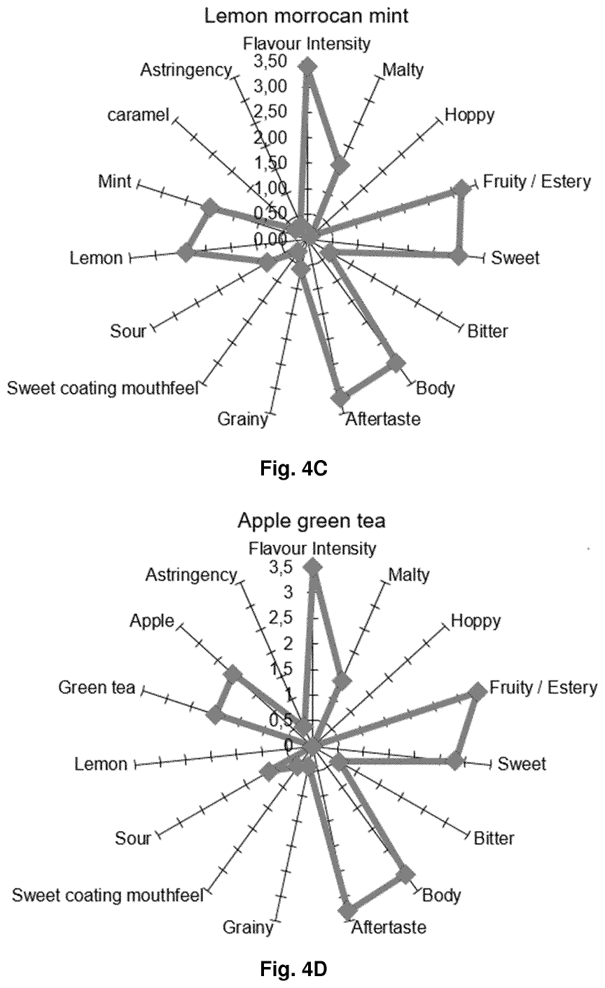

The flavour profiles of the beverage or beverage base with Nordic berries-rosemary flavour (FIG. 4A), Lime-Elderflower flavour (FIG. 4B), Lemon-mint (FIG. 4C) and Appel-Green tea (FIG. 4D) are shown in FIG. 4.

1. A method of producing a beverage or a beverage base, comprising the steps of:
i) preparing an aqueous extract of unmalted barley grains, wherein
at least 10% of the barley is a hull-less barley; or
at least 10% of the barley grains are pearled barley grains,
ii) fermenting the aqueous extract with yeast by cold contact fermentation or with inactivated yeast to obtain a fermented aqueous extract, and
iii) mixing said aqueous extract or fermented aqueous extract with a juice, thereby obtaining a beverage or a beverage base,
wherein step iii) can be performed at any time during the method.

2. (canceled)

3. The method of claim 1, wherein step i) comprises mashing milled barley grains in an aqueous solution in the presence of one or more exogenous enzymes selected from the group consisting of a cellulase, a protease, a pullulanase, a xylanase, and an amylase.

4. The method according to claim 1, wherein the step i) comprises mashing milled barley grains in an aqueous solution in the presence of one or more exogenous amylases selected from the group consisting of glucoamylase and alpha-amylase.

5. The method of claim 1, wherein the method further comprises a filtering step.

6. The method of claim 5, wherein the filtering step is performed after one or more of steps i), ii) and iii), in particular after step ii).

7. The method according to claim 1, wherein the method further comprises one or more of the following steps:
adding one or more additional compounds
incubating the aqueous extract, the fermented aqueous extract or the beverage base with a plant material
carbonating the beverage base.

8. The method according to claim 1 7, wherein at least 20%, such as at least 30%, such as at least 40%, such as at least 50%, such as at least 60%, such as at least 70%, such as at least 80%, such as at least 90%, such as 100% of the barley is a hull-less barley.

9. The method according to claim 1, wherein at least 10% of the barley is pearled barley, such as at least 20%, such as at least 30%, such as at least 40%, such as at least 50%, such as at least 60%, such as at least 70%, such as at least 80%, such as at least 90%, such as 100% of the barley is pearled barley.

10. The method according to claim 1, wherein at least some of the barley is a barley plant carrying one or more of the following mutations:
a mutation in the gene encoding LOX-1 causing a total loss of LOX-1 function
a mutation in the gene encoding LOX-2 causing a total loss of LOX-2 function
a mutation in the gene encoding MMT causing a total loss of MMT function.

11. (canceled)

12. The method of claim 1, wherein cold contact fermentation and incubation with juice are performed at a temperature below 4° C., such as below 3° C., such as below 2° C., such as below 1° C., such as below 0.5° C., such as below 0.4° C., such as below 0.3° C., such as 0.2° C.

13. The method of claim 1 wherein the juice is fruit juice, such as apple juice, orange juice, lemon juice, pomegranate juice, rhubarb juice, grape juice, preferably apple juice.

14. The method of claim 1, wherein the juice is vegetable juice, such as carrot juice.

15. The method of claim 1, wherein the mixing of aqueous extract or fermented aqueous extract with juice is performed with 2 to 40% of juice, 3 to 30% of juice, 4 to 20% of juice, or 5 to 15%.

16. A beverage comprising a beverage base prepared by the method according to claim 1 and one or more additional compounds and/or additional liquids.

17. A beverage comprising a beverage base prepared by the method according to claim 1, wherein said fermented aqueous extract is characterized by having:
6.5 to 7.5° Plato
0.0 to 0.3% alcohol
3 to 5 pH
0.0 to 0.2 ppm vicinal diketones (VDK)
0 to 100 ppb diacetyl

18. A beverage or beverage base according to claim 17 further characterized by having:
0 to 10 BU, bitterness

19. A beverage comprising a beverage base prepared by the method according to claim 1, wherein said beverage or beverage base is characterized by having:
7.5 to 8.5° Plato
0.0 to 0.05% alcohol
3.5 to 4.5 pH
0.0 to 0.2 ppm vicinal diketones (VDK)
0 to 50 ppb diacetyl
5 to 7 g/l fermented sugars
5 to 15 ppm SO2

20. A beverage or beverage base according to claim 19 further characterized by having:
0 to 5 BU, bitterness.
